(19) United States
(12) Patent Application Publication
(10) Pub. No.: US 2012/0182538 A1
(43) Pub. Date: Jul. 19, 2012

(54) Methods and Apparatus for Inspection Of Articles, EUV Lithography Reticles, Lithography Apparatus and Method of Manufacturing Devices

(75) Inventors: Roelof Koole, Eindhoven (NL); Vadim Yevgenyevich Banine, Deurne (NL); Luigi Scaccabarozzi, Valkenswaard (NL); Oktay Yildirim, Eindhoven (NL)

(73) Assignee: ASML Netherlands B.V., Veldhoven (NL)

(21) Appl. No.: 13/186,034

(22) Filed: Jul. 19, 2011

Related U.S. Application Data
(60) Provisional application No. 61/369,916, filed on Aug. 2, 2010.

(51) Int. Cl. G03B 27/62; G01N 21/956

(52) U.S. Cl. 355/75; 356/237.3

(57) ABSTRACT

An article such as an EUV lithography reticle is inspected to detect contaminant particles. The method comprises applying a fluorescent dye material to the article, illuminating the article with radiation at wavelengths suitable for exciting the fluorescent dye, monitoring the article for emission of second radiation by the fluorescent dye at a wavelength different from the first radiation, and generating a signal representing contamination in the event of detecting the second radiation. In one example, measures such as low-affinity coatings may be applied to the reticle to reduce affinity for the dye molecules, while the dye molecules will bind by physical or chemical adsorption to the contaminant particles. Dyes may be selected to have fluorescence behavior enhanced by hydrophobicity or hydrophilicity, and contaminant surfaces treated by buffer coatings accordingly.

### CROSS REFERENCE TO RELATED APPLICATIONS

This application claims benefit under 35 U.S.C. 119(e) to U.S. Provisional Application No. 61/369,916, filed Aug. 2, 2010, which is incorporated by reference herein in its entirety.

### BACKGROUND OF THE INVENTION

1. Field

The invention relates to inspection of articles, and may be applied for example to inspection of patterned articles in the field of lithography. In that example, the article to be inspected can for example be a reticle or other patterning device. The invention has been developed particularly for inspection of reticles used in EUV lithography, but is not limited to such application. The invention provides methods and apparatuses for use in inspection, lithographic apparatus, and reticles adapted for inspection by such methods.

2. Background

Lithography is widely recognized as one of the key steps in the manufacture of integrated circuits (ICs) and other devices and/or structures. However, as the dimensions of features made using lithography become smaller, lithography is becoming a more critical factor for enabling miniature IC or other devices and/or structures to be manufactured.

A lithographic apparatus is a machine that applies a desired pattern onto a substrate, usually onto a target portion of the substrate. A lithographic apparatus can be used, for example, in the manufacture of ICs. In that instance, a patterning device, which is alternatively referred to as a mask or a reticle, may be used to generate a circuit pattern to be formed on an individual layer of the IC. This pattern can be transferred onto a target portion (e.g., including part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned.

Current lithography systems project mask pattern features that are extremely small. Dust or extraneous particulate matter appearing on the surface of the reticle can adversely affect the resulting product. Any particulate matter that deposits on the reticle before or during a lithographic process is likely to distort features in the pattern being projected onto a substrate. Therefore, the smaller the feature size, the smaller the size of particles critical to eliminate from the reticle.

A pellicle is often used with a reticle. A pellicle is a thin transparent layer that may be stretched over a frame above the surface of a reticle. Pellicles are used to block particles from reaching the patterned side of a reticle surface. Although particles on the pellicle surface are out of the focal plane and should not form an image on the wafer being exposed, it is still preferable to keep the pellicle surfaces as particle-free as possible.

A theoretical estimate of the limits of pattern printing can be given by the Rayleigh criterion for resolution as shown in equation (1):

$$CD = {k}_{1} * \frac{λ}{{NA}_{PS}} \qquad ( 1 )$$

where λ is the wavelength of the radiation used, NAₚₛ is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NAPS or by decreasing the value of k₁.

In order to shorten the exposure wavelength and, thus, reduce the minimum printable size, it has been proposed to use an extreme ultraviolet (EUV) radiation source. EUV radiation sources are typically configured to output a radiation wavelengths of around 5-20 nm, for example, 13.5 nm or about 13 nm. Thus, EUV radiation sources may constitute a significant step toward achieving small features printing. Such radiation is termed extreme ultraviolet or soft x-ray, and possible sources include, for example, laser-produced plasma sources, discharge plasma sources, or synchrotron radiation from electron storage rings.

For EUV lithography processes, however, pellicles are not used, because they would attenuate the imaging radiation. When reticles are not covered, they are prone to particle contamination, which may cause defects in a lithographic process. Particles on EUV reticles are one of the main sources of imaging defects. An EUV reticle (or other reticle for which no pellicle is employed) is likely to be subjected to organic and inorganic particle contamination. Particle sizes as small as around 20 nm could lead to fatal defects on the wafer and to zero yield.

Inspection and cleaning of an EUV reticle before moving the reticle to an exposure position can be an important aspect of a reticle handling process. Reticles are typically cleaned when contamination is suspected, as a result of inspection, or on the basis of historical statistics.

Reticles are typically inspected with optical techniques. However, a pattern scatters light exactly in the same way as a particle does. The pattern of a reticle surface is arbitrary (i.e., non-periodic), and so there is no way to distinguish a particle from the pattern by simply analyzing the scattered light. A reference is always required with these optical techniques, either die-to-die, or die-to-database. Moreover, existing inspection tools are expensive and relatively slow.

### SUMMARY

Therefore what is needed is an object inspection system that can operate at high speed and that can detect particles of small size, for example of a size of 100 nm or less, 50 nm or less, or 20 nm or less. What is also needed is a technique that can detect particles that are present on the patterned side of a patterning devices such as a reticle, used in an EUV lithographic apparatus.

According to a first aspect of the present invention, there is provided a method for inspection of an article, for example an lithography reticle, to detect contaminant particles, the method comprising: applying a fluorescent dye material to the article, illuminating the article with radiation at wavelengths suitable for exciting the fluorescent dye, monitoring the article for emission of second radiation by the fluorescent dye at a wavelength different from the first radiation, and generating a signal representing contamination in the event of detecting the second radiation.

The fluorescent dye may be selected to bind to the contaminant particles, and the article may be adapted by coatings or other means to enhance contrast by reducing affinity of the reticle for the dye. Bridging molecules may be used and designed further to enhance selectivity of binding. Buffer molecules, which may or may not serve additionally for binding, the dye, can modify the environment of the dye on the contaminant particle, so as to modify the fluorescence in one or more properties. Particular dyes may be selected that are sensitive to the pH of their environment, for example, and/or to hydrophobicity and hydrophilicity of neighboring molecules. Alternatively or in addition, some or part of the article may be effective to suppress fluorescence, even while dye is present. (This suppression can be achieved by modification of the article surface, without destroying its primary function as for example an EUV reticle.)

According to a second aspect of the present invention, there is provided an apparatus for inspection of apparatus for inspection of articles such as reticles used in lithography, the inspection apparatus comprising a support for the patterning device under inspection, a source optical system comprising: a deposition chamber for applying a fluorescent dye material to the article,
a radiation source for illuminating the object with radiation at wavelengths suitable for exciting the fluorescent dye, a sensor for monitoring the article for emission of second radiation by the fluorescent dye at a wavelength different from the first radiation, and a signal processor for generating a signal indicating the presence of contamination in response to detection of the second radiation.

According to a third aspect of the present invention, there is provided a reticle for use as a patterning device in EUV lithography, the device having reflective portions and absorbing portions of contrasting optical properties at EUV wavelengths, and wherein an overall coating is applied for enhancing contrast between the reticle and contaminant particles in an inspection method without significantly reducing contrast between the optical properties at EUV wavelengths.

According to a fourth aspect of the present invention, there is provided a computer program product including instructions that, when executed upon a computer enable it to carry out a data analysis method for use in the method of the first aspect.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention. Embodiments of the invention are described, by way of example only, with reference to the accompanying drawings, in which:

FIG. 1 depicts schematically a lithographic apparatus having reflective projection optics,

FIG. 2 is a more detailed view of the apparatus of FIG. 1,

FIG. 3 is a more detailed view of an alternative source collector module SO for the apparatus of FIGS. 1 and 2,

FIG. 4 depicts an alternative example of an EUV lithographic apparatus,

FIG. 5 depicts an EUV reticle with contaminant particles,

FIGS. 6A-6B depict schematically an apparatus for inspection of an object according to an embodiment of the present invention and illustrates principles of operation of an inspection process for EUV reticles,

FIGS. 7A-7E illustrate stages of a first embodiment of an inspection process using the apparatus of FIGS. 6A-6B,

FIGS. 8A-8D illustrate part of the inspection process in a second embodiment of the invention,

FIGS. 9A-9B illustrate part of the inspection process in a third embodiment of the invention,

FIGS. 10A-10C illustrate part of the inspection process in a fourth embodiment of the invention,

FIG. 11 illustrates part of the inspection process in a fifth embodiment of the invention,

FIGS. 12A-12D illustrates quenching mechanisms that can be exploited in the processes of the fifth and sixth embodiments of the invention,

FIG. 13 illustrates part of the inspection process in a fifth embodiment of the invention,

FIGS. 14 and 15 illustrate the influence of environment on the fluorescence spectrum of an example dye, and

FIGS. 16 to 20 illustrate farther embodiments of the invention, exploiting the influence of environmental on different dyes.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiments) merely exemplify the present invention. The scope of the present invention is not limited to the disclosed embodiment(s). The present invention is defined by the claims appended hereto.

The embodiment(s) described, and references in the specification to “one embodiment”,” “an embodiment”,” “an example embodiment”,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the present invention may be implemented in hardware, firmware, software, or any combination thereof. Embodiments of the present invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

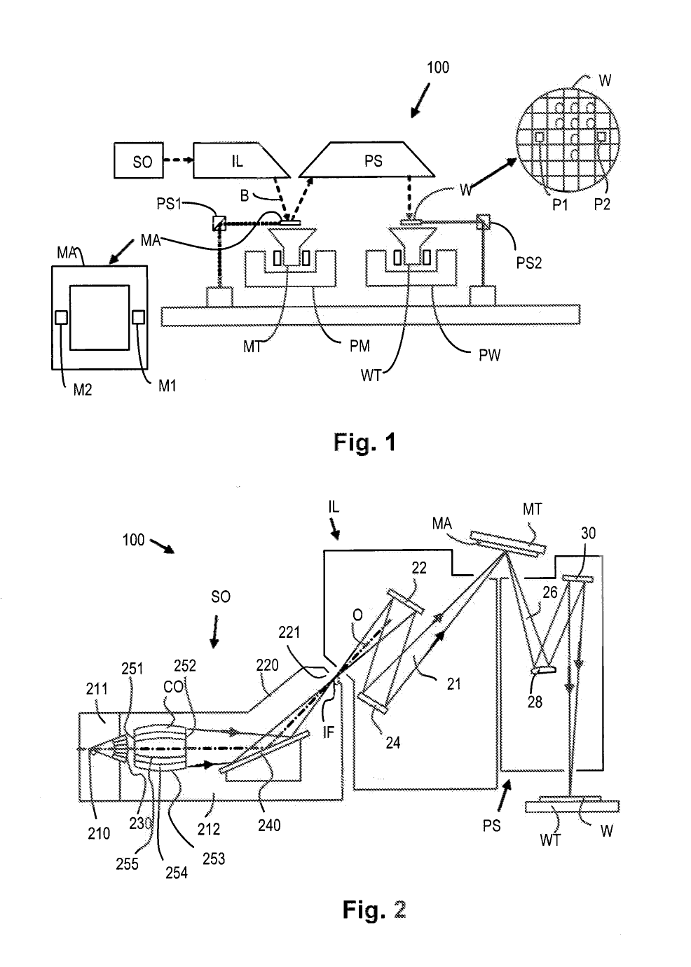

FIG. 1 schematically depicts a lithographic apparatus 100 including a source collector module SO according to one embodiment of the invention. The apparatus comprises an illumination system (illuminator) IL configured to condition a radiation beam B (e.g., EUV radiation), a support structure (e.g., a mask table) MT constructed to support a patterning device (e.g., a mask or a reticle) MA and connected to a first positioner PM configured to accurately position the patterning device, a substrate table (e.g., a wafer table) WT constructed to hold a substrate (e.g., a resist coated wafer) W and connected to a second positioner PW configured to accurately position the substrate, and a projection system (e.g., a reflective projection system) PS configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since other gases may absorb too much radiation. A vacuum environment may therefore be provided to the whole beam path with the aid of a vacuum wall and vacuum pumps.

As here depicted, the apparatus is of a reflective type (e.g., employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultra violet radiation beam from the source collector module SO. Methods to produce EUV light include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel, such as a droplet, stream or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g., EUV radiation, which is collected using a radiation collector, disposed in the source collector module. The laser and the source collector module may be separate entities, for example when a CO2 laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors and/or a beam expander. In other cases the source may be an integral part of the source collector module, for example when the source is a discharge produced plasma EUV generator, often termed as a DPP source.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. After being reflected from the patterning device (e.g., mask) MA, the radiation beam B passes through the projection system PS, which focuses the beam onto a target portion C of the substrate W. With the aid of the second positioner PW and position sensor PS2 (e.g., an interferometric device, linear encoder or capacitive sensor), the substrate table WT can be moved accurately, e.g., so as to position different target portions C in the path of the radiation beam B. Similarly, the first positioner PM and another position sensor PS1 can be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

The depicted apparatus could be used in at least one of the following modes:

1. In step mode, the support structure (e.g., mask table) MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed.

2. n scan mode, the support structure (e.g., mask table) MT and the substrate table WT are scanned synchronously while a pattern imparted to the radiation beam is projected onto a target portion C (i.e., a single dynamic exposure). The velocity and direction of the substrate table WT relative to the support structure (e.g., mask table) MT may be determined by the (de-)magnification and image reversal characteristics of the projection system PS.

3. In another mode, the support structure (e.g., mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

It has been proposed to use the presence or absence of a photoluminescence (PL) signal as an indicator of the presence of a defect, see for example JP 2007/258567 or JP 11304717, which are incorporated by reference herein in their entireties. However, improvements to the particle detection capabilities of these techniques would be welcomed. A spectroscopic approach to detection of contaminants has been proposed in co-owned international patent application PCT/EP2010/059460, which was filed on 2 Jul. 2010 and claims priority from U.S. provisional application 61/231,161, filed on 4 Aug. 2009, which are incorporated by reference herein in their entireties.

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO. An EUV radiation emitting plasma 210 may be formed by a discharge produced plasma source. EUV radiation may be produced by a gas or vapor, for example Xe gas, Li vapor or Sn vapor in which the very hot plasma 210 is created to emit radiation in the EUV range of the electromagnetic spectrum. The very hot plasma 210 is created by, for example, an electrical discharge causing an at least partially ionized plasma. Partial pressures of, for example, 10 Pa of Xe, Li, Sn vapor or any other suitable gas or vapor may be required for efficient generation of the radiation. In an embodiment, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contamination trap 230 may also include a gas barrier or a combination of a gas barrier and a channel structure. The contaminant trap or contaminant barrier 230 further indicated herein at least includes a channel structure, as known in the art.

The collector chamber 211 may include a radiation collector CO which may be a so-called grazing incidence collector. Radiation collector CO has an upstream radiation collector side 251 and a downstream radiation collector side 252. Radiation that traverses collector CO can be reflected off a grating spectral filter 240 to be focused in a virtual source point IF. The virtual source point IF is commonly referred to as the intermediate focus, and the source collector module is arranged such that the intermediate focus IF is located at or near an opening 221 in the enclosing structure 220. The virtual source point IF is an image of the radiation emitting plasma 210.

Subsequently the radiation traverses the illumination system IL, which may include a facetted field min or device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the wafer stage or substrate table WT.

More elements than shown may generally be present in illumination optics unit IL and projection system PS. The grating spectral filter 240 may optionally be present, depending upon the type of lithographic apparatus. Further, there may be more mirrors present than those shown in the Figures, for example there may be 1-6 additional reflective elements present in the projection system PS than shown in FIG. 2.

Collector optic CO, as illustrated in FIG. 2, is depicted as a nested collector with grazing incidence reflectors 253, 254 and 255, just as an example of a collector (or collector mirror). The grazing incidence reflectors 253, 254 and 255 are disposed axially symmetric around an optical axis O and a collector optic CO of this type is preferably used in combination with a discharge produced plasma source, often called a DPP source.

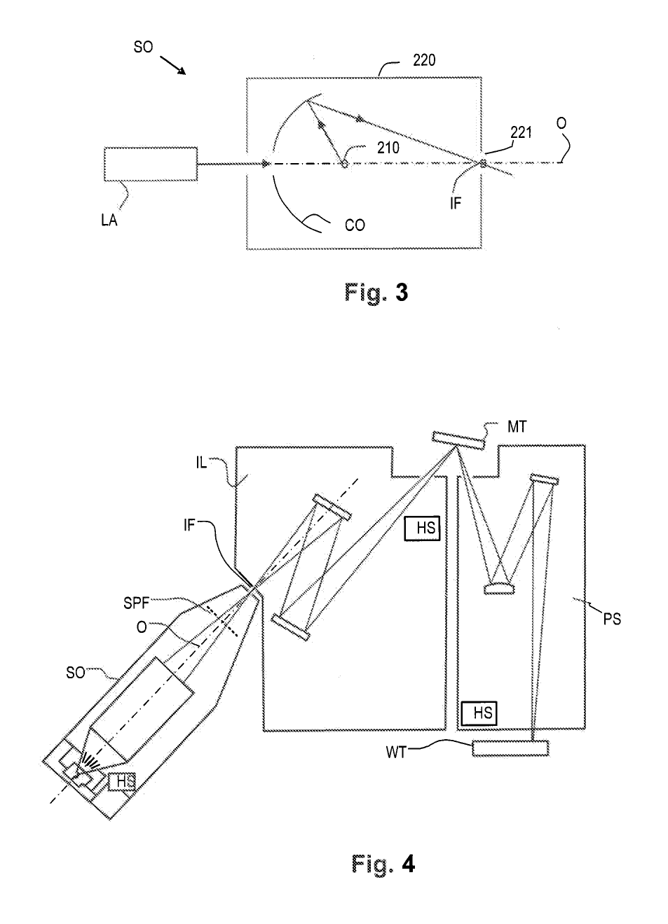

Alternatively, the source collector module SO may be part of an LPP radiation system as shown in FIG. 3. A laser LA is arranged to deposit laser energy into a fuel, such as xenon (Xe), tin (Sn) or lithium (Li), creating the highly ionized plasma 210 with electron temperatures of several 10's of eV. The energetic radiation generated during de-excitation and recombination of these ions is emitted from the plasma, collected by a near normal incidence collector optic CO and focused onto the opening 221 in the enclosing structure 220.

FIG. 4 shows an alternative arrangement for an EUV lithographic apparatus in which the spectral purity filter SPF is of a transmissive type, rather than a reflective grating. The radiation from source collector module SO in this case follows a straight path from the collector to the intermediate focus IF (virtual source point). In alternative embodiments, not shown, the spectral purity filter 11 may be positioned at the virtual source point 12 or at any point between the collector 10 and the virtual source point 12. The filter can be placed at other locations in the radiation path, for example downstream of the virtual source point 12. Multiple filters can be deployed. As in the previous examples, the collector CO may be of the grazing incidence type (FIG. 2) or of the direct reflector type (FIG. 3).

The following description presents systems and methods of object inspection that allow the detection of particles on the object. The object to be inspected can be, for example, a lithographic patterning device for generating a circuit pattern to be formed on an individual layer in an integrated circuit. Example patterning devices include a mask, a reticle, or a dynamic patterning device. Reticles for which the system can be used include for example reticles with periodic patterns and reticles with non-periodic patterns. The reticles can also be for use within any lithography process, such as EUV lithography and imprint lithography for example.

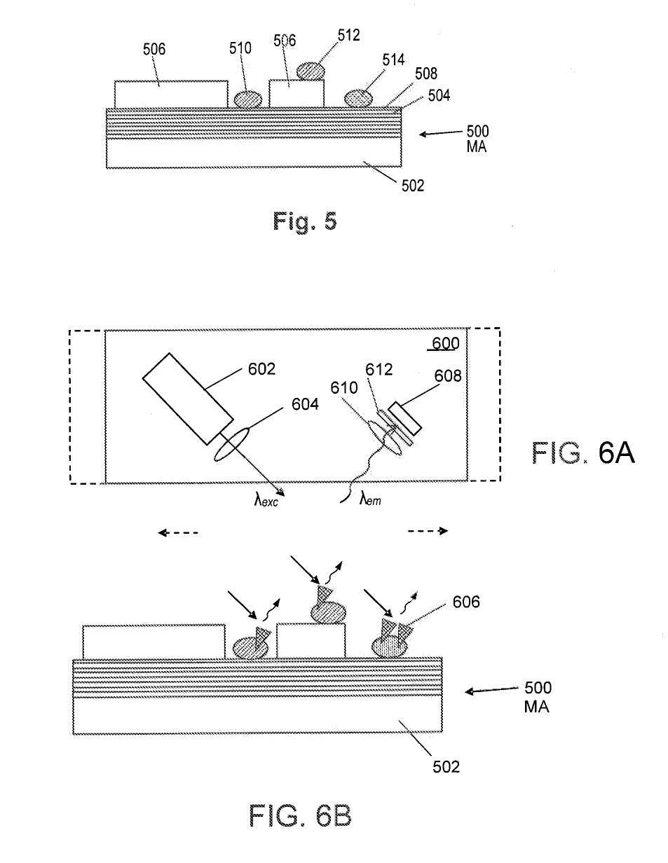

FIG. 5 illustrates a typical EUV reticle 500 in cross section, which may be the patterning device MA in any of the lithographic apparatuses of FIGS. 1 to 4. Reticle 500 comprises a substrate 502, multilayer coating 504 and pattern layer 506.

In one example embodiment the reticle 500 can be a EUV reticle including a substrate 502 formed from quartz or another low thermal expansion material, and a reflective multilayer coating 504 including alternate molybdenum and silicon layers. The multilayer coating 504 may for example include several tens of layers and can in one example have a thickness of about 200 nm. A capping layer 508 can also be provided at the top surface of the multilayer, being formed for example from ruthenium or silicon.

The pattern layer 506 defines a pattern for the reticle 500. In the case of an EUV reticle the pattern layer 506 is an absorber layer. Similarly, the multilayer 504 in an EUV reticle is reflective.

The pattern layer 506 in an EUV reticle can for example be formed from tantalum nitride (TaN). There may be a surface layer of TaNO. The height of the absorber may in one example be approximately 70 nanometers, and it can have a width of approximately 100 nm (which is approximately four times the critical dimension (CD) of the lithography system, the scaling being due to the demagnification factor between wafer and reticle).

The pattern defined by the pattern layer is in principle arbitrary and can be composed of lines, contact holes, periodic and non periodic patterns.

The diagram also shows contaminant particles 510, 512 and 514. These are not part of the reticle 500 but may be adsorbed or deposited on the reticle 500 in some situations. Because a lithography apparatus is complicated and utilizes many different materials, any type of particle can in principle be deposited on the reticle 500. The particles can be conductive or insulating, they can be of any shape or size and could be deposited on the conductive coating 504 or the pattern layer 506. Example types of particle that might be deposited include organic particles, metal particles and metal oxide particles.

Particles which gather on a surface of a patterning device such as a reticle used in a lithographic apparatus will in general be of a different type of material from those materials from which the patterning device is formed. In the examples which follow (FIGS. 6A-6B, 7A-7E, 8A-8D, 9A-9B, 10A-10C and 11), this fact is exploited to aid in the detection of contaminant particles by use of one or more fluorescent dye materials. Further, techniques are described to detect contamination even when the materials of the contaminant particles and the reticle are not, in themselves, so different. It is proposed to perform inspection of EUV reticles by using organic fluorescent dyes. The bright fluorescence of dyes allows for very sensitive inspection. The dyes are deposited on the reticles by vapor deposition, and selectively bind to the contaminants. Selectivity in binding can be achieved in various ways, illustrated in the various embodiments which follow. Options include applying a low-affinity coating on top of the reticle, and/or by adding functional groups to the dye that specifically binds to the contaminants. A higher contrast can be achieved by use of an additional (selective) removal step of excess dye on the reticle.

While some embodiments achieve contrast by selective binding of dye to contaminant material, other embodiments achieve contrast without selective binding. In these embodiments, quenching mechanisms operate so that only those dye molecules which are bound to contaminant material will emit radiation to be detected. Subsequently inspection can be performed, followed by cleaning. Different techniques can be combined to make a practical embodiment. Different techniques may be applied in parallel or sequentially, to detect different types of contamination, and/or to detect contamination present on different parts of the reticle (e.g., conductive coating 504/508 or the pattern layer 506).

FIGS. 6A-6B illustrate the principles of the particle detection methods disclosed herein. An inspection apparatus 600 is provided which includes a radiation source 602 which illuminates reticle 500 via illumination optics 604. Fluorescent dye comprising molecules 606 have been attached to the contaminant particles 510-514. Source 602 provides illumination at excitation wavelength λ_{exc}. Dye molecules 606 are brought into an excited state by this illumination after which they can emit radiation at a different wavelength λₑₘ. Detection optics 610 including a filter 612 collect the emitted radiation and deliver it to sensor 608, which may be a camera (pixel array) or a single sensor (e.g., a photomultiplier tube, PMT). As shown by the dashed outline and dashed arrows, scanning movements can be applied so that inspection apparatus 600 systematically covers the surface of reticle 500 for complete inspection.

Inspection apparatus 600 may be integrated within the reticle housing of the lithographic apparatus, so that the reticle under inspection is mounted on the same support structure MT used during lithographic operations. Alternatively, reticle 500 may be removed from the immediate vicinity of support structure MT to a separate inspection chamber. This latter option avoids crowding the lithographic apparatus with additional equipment, and also permits the use of processes that would not be permitted or would be undesirable to perform within the lithographic apparatus itself. The inspection chamber can be closely coupled to the lithographic apparatus, or quite separate from it, according to preference. The inspection chamber may itself be divided into an inspection chamber where the apparatus 600 operates and a preparation chamber (not shown) where dye is applied to the reticle.

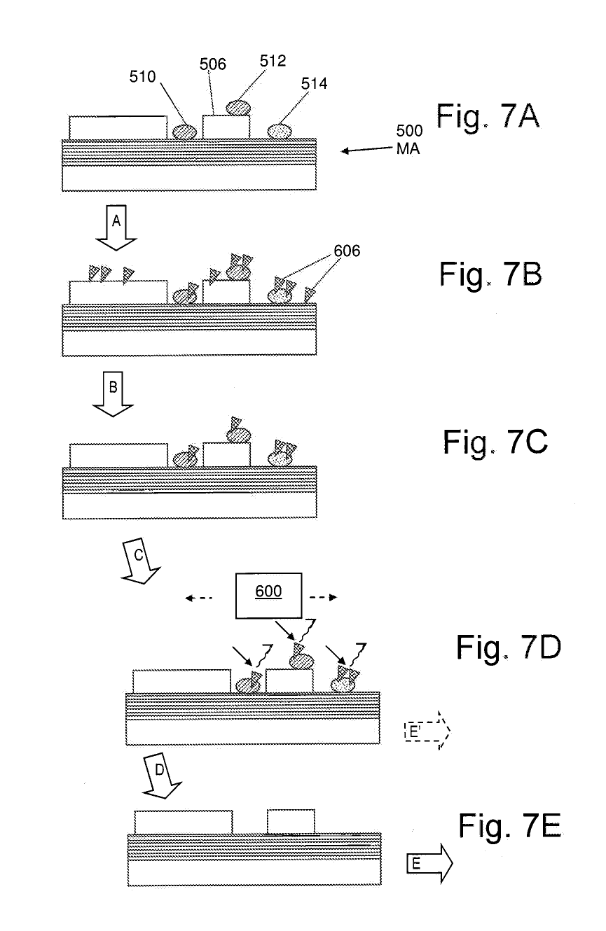

Referring to FIGS. 7A-7E, a first embodiment of a complete inspection and cleaning process is illustrated. The reticle 500 with contaminant particles 510-514 is received at 7A. A process A is applied to deposit fluorescent dye molecules 606 onto it. This deposition will generally be by vapor deposition from an atmosphere in which dye vapor exists, and in which the vapor pressure and the temperatures of vapor and substrate are closely controlled. In this first embodiment, the dye is deposited uniformly across the reticle (FIG. 7B), including on the contaminant and on the reticle itself.

To provide or enhance contrast, there is then performed a dye removal step B, whereby the dye remains adsorbed to the particles 510-514, but is removed from the reticle layers 560, 508 (FIG. 7C). To achieve a high contrast, a very low affinity of the reticle for the dye is desired. For example, the dye is chosen to have (strong) chemisorption to the contamination but only (weak) physisorption (such as van der Waals bonding) towards the substrate. To that aim, the dye can have a functional group that specifically binds (chemisorption) to the contamination, but not to the substrate. By flushing the atmosphere while heating the substrate to a suitable temperature, the weaker bonds can be broken to drive off the dye molecules that are not chemically bonded to contaminant particles.

After dye removal process B, the reticle is transferred by process C to the inspection chamber, or the inspection apparatus 600 is brought into the chamber, and the excitation and detection of fluorescence is performed to determine whether contaminant particles are present on the reticle (FIG. 7D), if desired, the detection process can be performed with spatial resolution to identify where on the reticle the particles are located, or this may not be of interest. Assuming particles are found, a cleaning process D is performed to remove the particles and the clean reticle (FIG. 7E) is transferred by step E to the lithographic apparatus, or to storage, for future use. Cleaning is by a non-contact process, for example by exposing the reticle to an atmosphere of hydrogen radicals.

If no fluorescence is detected, which is to be hoped for, the reticle is judged clean and transferred E′ to use or storage, without cleaning step D. Since the reticles are extremely expensive and delicate products, a key aim of the inspection process is to avoid unnecessary cleaning operations. Note that, if the selective dye removal step B is efficiently performed, there is no need to remove the dyes, if no contamination is found.

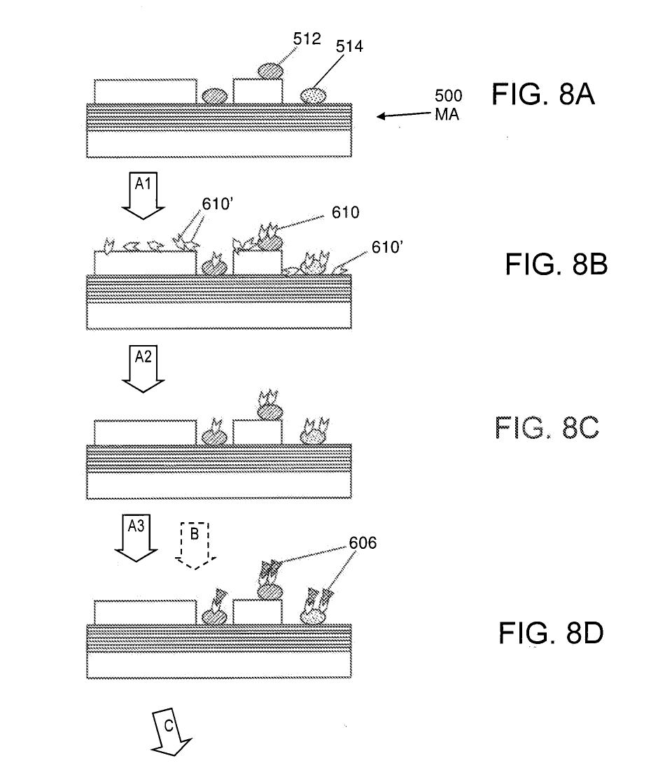

Referring to FIGS. 8A-8D, an alternative process for achieving selective binding of dye to contaminant particles is illustrated, as a second embodiment of the invention. Here, the step A is not performed directly, but rather steps A1-A3 are applied as follows. In step A1, a bridging molecule 610 is selected and deposited across the substrate. Bridging molecule 610 has a first functional group which binds efficiently to the target particles but not to the reticle. A second functional group binds efficiently to the dye. After introducing the bridging molecules to the preparation chamber in step A1, some of them 610 will be relatively strongly bound to the particles 510-514, while others labeled 610′ lying on the reticle itself will be relatively loosely bound. In step A2 the surface is flushed of these loosely bound molecules 610′, by one or more cycles of evacuating the bridging molecule atmosphere, heating to an appropriate temperature and flushing with inert gas such as N₂. At this point (c), bridging molecules are present only where they are bound to the contaminant particles and where they provide receptor sites for dye molecules. Dye molecules are then introduced in step A3 which bind to the bridging molecules. Further flushing operations B are performed if necessary to remove excess dye molecules, leaving only the molecules which are bound to bridging molecules bound to the particles 510-514 (FIG. 8D).

Note that at least three variants are possible, within the general concept of the second embodiment. Starting with the process just described with reference to FIGS. 8A-8D, these variants are: (1) apply bridge molecule, flush, then apply dye, and flush again if necessary; (2) apply bridge molecule, then apply dye, then flush; and (3) apply bridge molecule and dye simultaneously, then flush. The skilled reader will be able by experiment to arrive at the process best suited to a particular combination of reticle materials & coatings, contaminant compositions, dye composition and bridging molecule. Note that in the second embodiment, the bridging molecule and dye will be absent if no contamination is present, in which case no specific steps will be required to remove them.

With regard to selectivity, the dye molecules/bridging molecules can either bind to a substrate by physisorption, dominated by van der Waals interactions, or by chemisorption, where in fact a chemical bond is created between dye and substrate. Ideally, the dye chemisorbs to the particles and only shows weak physisorption towards the substrate. In other words, a high contrast in affinity of the dye towards the reticle and particles is desired.

As mentioned, the surface material of the reticle in the reflective portion may be material of the Mo/Si multilayers 504, or a capping layer 508 such as Ru. The surface of the absorber material forming the pattern layer 506 may for example be TaN or TaNO. The types of metals and metal oxides that may be encountered as contamination include Al, Fe, Zn, Ti, Cu, Ni, W, Sn, Na, K, Mg. Organic contaminants may also be encountered. At least some organic contaminants may fluoresce on their own, without the addition of dye. It may still be beneficial to attach dye to them, however to strengthen the emission signal.

A suitable dye has to be selected that has a high affinity for the contamination, but low affinity for the reticle substrate/coating. Affinity may be effected by purely physical interactions (‘physisorption’), or by chemical interactions too (‘chemisorption’). If only physisorption is concerned, the hydrophobicity of the dye is the main property to vary for this purpose. For example, a hydrophilic dye will adhere to a metal oxide particle in preference to a hydrophobic substrate. In the event that physisorption alone does not provide enough contrast in binding strength between the article being inspected and the contamination, in a given situation, chemisorption can be brought into play. To achieve chemisorption towards the contamination, the dye may have a functional group that specifically binds to metals or semiconductors, for example. Preferably the dye has a low vapor pressure to facilitate vapor deposition and (selective) removal of the dye. For choosing a fluorescent dye, the following are just some examples of the types can be selected, either individually or in combination: Coumarin-based, Fluorescein-based, Nile blue, Perylene-based, Anthracene-based, Biphenyl-based, Naphtalene-based, Acridine-based, and Oxazine-based.

There is also a choice of functional binding groups which can be attached to the basic dye molecule to bind with the particles. In principle, individually customized formulations can be made to bind to specific materials on the reticle or in the contaminant particles. However, it is desirable if one can use one of the functional groups that are already available commercially for medical/pharmaceutical investigations. Dye molecules equipped with one of these binding groups commercially available: Thiol, Cyanide, Amine, Carboxyl, Hydroxyl, Thiocyanide, Chlorosilane, and Alkoxysilane.

Other functional groups may also be available and useful, besides those listed. The correct performance in a given situation must be verified by experiment. As a starting point, however, it may be expected that the thiol, (thio)cyanide, and amine groups are likely to bind to metals, whereas the phosphates, phosphonates, carboxyl, hydroxyl and silanes are more likely to bind to metal oxides. To ensure adhesion of dyes to the various contaminants, one may choose to use a set of various dyes with different binding groups, or one dye carrying more than one binding group. In the first case, the spectral response during inspection can indicate the type of contamination that was found. This information may be useful for investigating the source of contamination for future improvements. It may also be useful for designing an optimal cleaning process to minimize cleaning time and/or to minimize degradation of the substrate. More information on the effect of environment on the spectral response of dyes will be given in further embodiments, below.

As mentioned, when the vapor deposition alone does not yield sufficient contrast between reticle and particle, a selective removal step of the excess dye on reticle can be performed (FIG. 7B). This can be done by several flushes of the vacuum atmosphere, in combination with heating the substrate. Depending on the dye and practical considerations, the temperature for such heating could be about 160 Celsius, for example. In other cases, it may need to be lower, for example around 140 Celsius. This removal in step B can be further enhanced by electron or ion bombardment of the substrate, or plasma treatment. In all cases it is evident that the process should be selective, so that it does not remove the dye from the particles, only from the reticle. This is feasible when there is a sufficient difference in affinity of the dye between the reticle and particle. In all cases the application and selective removal of the dye will be a process that has to be precisely tuned through experimentation, to optimize the selectivity of removal and maximize contrast.

In case the contrast in physical or chemical affinity of the dye towards reticle and contamination is not sufficiently large, an additional coating can be applied on top of the reticle of a preferred material that has a very low affinity for the dye. For instance, coating 802 might be, a low surface energy material such as BN, SiC, a fluorinated silane, or noble metals. Other materials, for example GeTe or MoS₂, may be selected for coating 802 because they are very hydrophobic and therefore have very low affinity for a hydrophilic dye. Embodiments exploiting sensitivity of certain dyes to hydrophobic or hydrophilic environments are described below with reference to FIGS. 14 to 20, below.

The coating should be reasonably transparent for EUV, to reduce the intensity loss to a minimum. To this end, it may be thinner than 2 nm, preferably thinner than 1 nm. Atomic layer deposition (ALD) is a convenient method to apply a coating of BN with a uniform thickness of only a few atomic layers. Where a metal is chosen for coating 802, this may include the customary Ru layer 508, but in the modified reticle 800 this is extended over the pattern layer TaN, not just the reflective multilayer 504. Whichever material is chosen as the low-affinity layer, it should be robust against EUV radiation and hydrogen atmosphere. It should neither attenuate the EUV reflectivity too much, nor cause reflectivity in the absorber portions of pattern layer 506. To this end, it may be thinner than 2 nm, preferably thinner than 1 nm.

Needless to say, where the preceding paragraph refers to the affinity of a coating for the dye, in the case of the second embodiment it may be that the coating is selected for its low affinity to a selected bridging molecule. Affinity for the dye and the bridging molecule may both be relevant, of course, and different coatings at different parts of the article may be desired to achieve the complete selectivity desired.

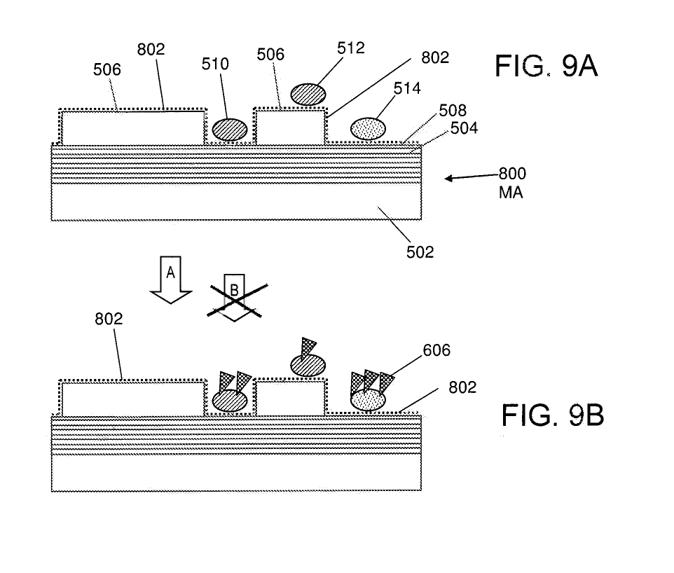

FIGS. 9A-9B illustrate a third embodiment in which the reticle 800 has been coated with a thin layer 802 of low-affinity material (FIG. 9A), as suggested in the previous paragraph. This is to enhance contrast, so that in step A the dye only sticks to the particles 510-514 and not to the (coated) reticle (FIG. 9B). The dye removal step B is not required before inspection is performed using apparatus 600.

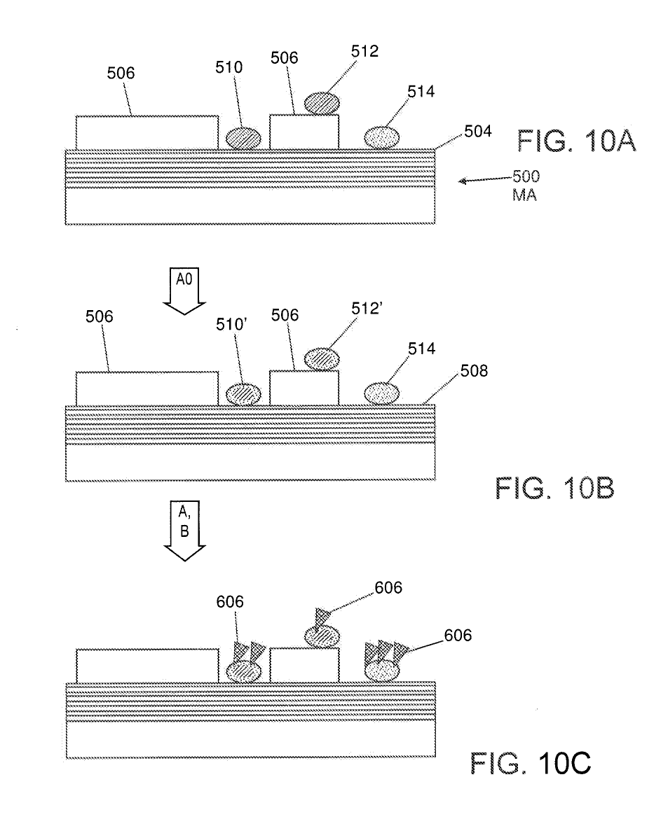

FIGS. 10A-10C illustrate a fourth embodiment using in which particles are modified prior to inspection, to enhance their affinity for the dye. As noted above, particles 510-514 may be of different materials. In FIG. 10A for example, particles 510 and 512 may be metal particles, while particle 514 is a metal oxide or organic particle. In a pre-processing step A0, metal particles 510 and 512 are wholly or partially oxidized (b) by exposure to an oxygen atmosphere in the above-mentioned preparation chamber. This can facilitate the selection of a dye having suitable contrasting behavior between the reticle and the particles, because the particles are now all more similar to one another than they are to the metal or semiconductor material of the clean reticle. Generally speaking, an oxidizing atmosphere will not be wanted in the lithographic apparatus itself. This is therefore an embodiment in which a separate preparation chamber for the inspection apparatus 600 is a particularly attractive option. Furthermore, the oxidization step should be mild enough that it does not oxidize and degrade the functional surfaces of the reticle itself, such as a Ru capping layer 508.

After the oxidation step A0, the reticle 500 is processed in the same way as in the previous embodiments to attach dye molecules selectively to the contaminant particles (FIG. 10C). Inspection then proceeds as before. Features such as the low-affinity coating 802 and/or the bridging molecules 610 can be applied in combination with the oxidizing step, if desired.

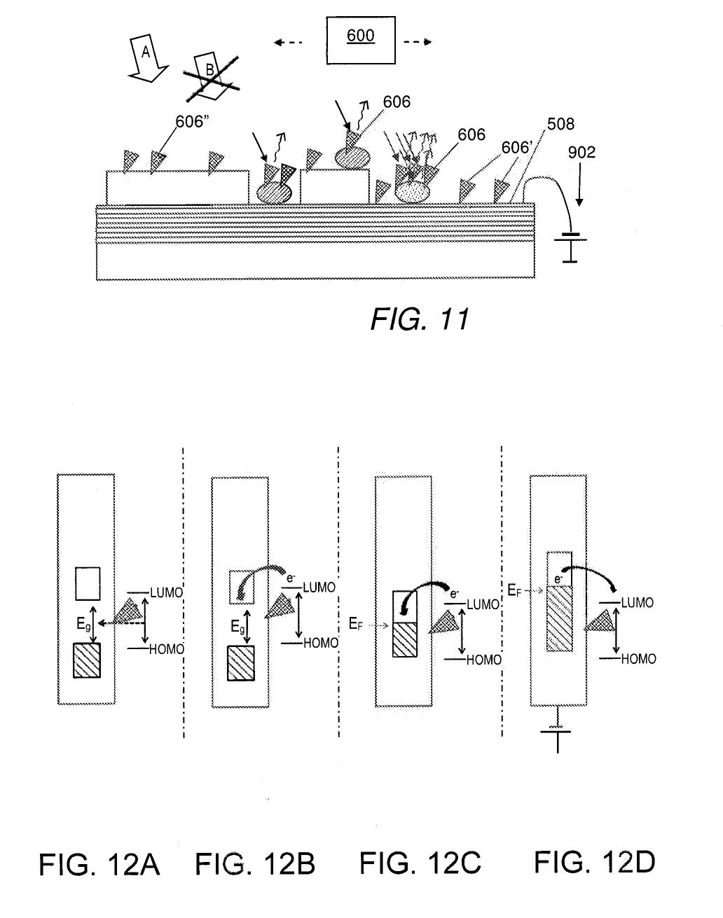

FIG. 11 illustrates a fifth embodiment of the invention, in which dye is not selectively bonded to the particles, but rather the dye molecules fluoresce selectively, depending on whether they lie on the reticle or on the particles. Specifically, dye molecules 606 which are adsorbed onto the contaminant particles will fluoresce normally, while molecules 606′ and 606″ which are on the reticle layers 508 and 506 respectively are ‘quenched’ by their proximity or contact to the reticle material, so as to suppress fluorescence. An electric bias source 902 may optionally be deployed to enhance the quenching, by applying a negative bias voltage to the substrate 502 and/or upper layers 506, 508 of the reticle 500. If the dyes and/or reticle materials can be selected so that this quenching will happen, the dye removal step B can be avoided. The need for dye to bind to the particles selectively is reduced, which potentially increases the range of materials from which to choose. Alternatively the dye removal step B may be still performed, but less thorough removal will be required to meet detection specifications.

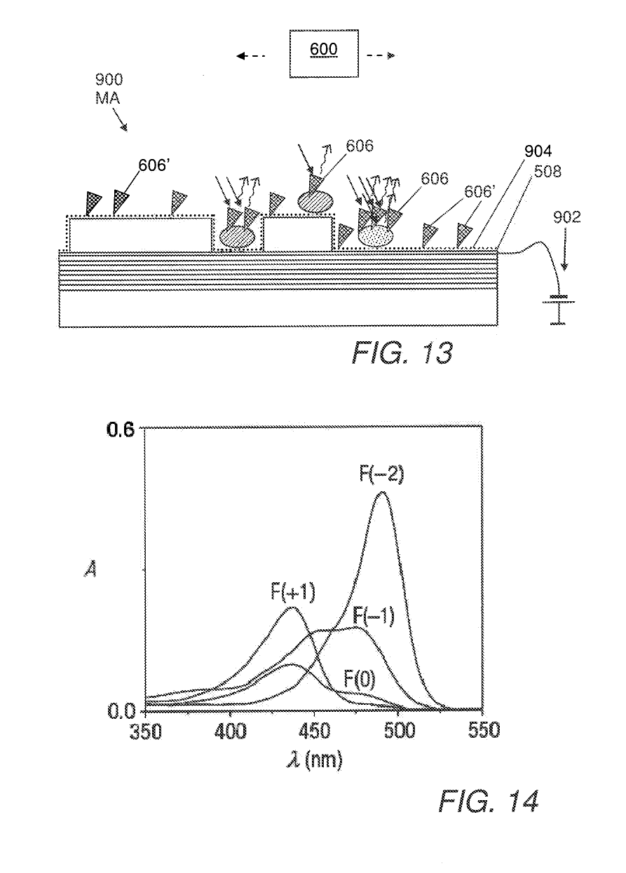

Preferably the substrate causes an efficient quenching of the dye by one of the mechanisms described below with reference to FIG. 13. The metallic properties of the reticle may be sufficient to cause a certain degree of quenching, depending on the choice of dye and the exact materials used.

The Ru and TaN materials, from which the reticle surface is customarily made, may be efficient quenchers by themselves. In case the conventional reticle materials do not sufficiently suppress the dye's fluorescence, one can either adapt the composition of the reticle, or apply a thin additional coating on top of a conventional reticle, similar to the coating 802 in reticle 800 (FIG. 9A). The thickness of this coating should be small enough not to interfere with the EUV optical performance of the reticles, for example less than 2 nm and preferably less than 1 nm in thickness. For this coating to be an efficient quencher, it may for example have a very low Fermi-level (charge-injection), a strong surface plasmon band or a transition dipole of a semiconductor (energy transfer). Examples are noble metals which generally have a low Fermi-level, or semiconductors with a large dipole moment (direct band gap) in the visible part of the EM spectrum, such as like Si, Ge, GaAs, InAs, InSb, PbSe. Metals like copper, silver or gold have plasmon bands in the visible region, and metals such as Ti, Ru, or Cr may also be applicable. Metals with a very high Fermi level such as Lithium or Magnesium may be used to inject charges into the dye. The material selected for coating 802 should be one which does not react and change in the operating environment of the article being inspected. In the case of an EUV lithography reticle, that is typically a near vacuum environment exposed to EUV radiation, H₂ gas and possibly atomic hydrogen also. The coating should also preferably be one which does not react with air, or handling the article becomes complicated.

It is noted that the properties of many materials change for very thin layers (<5 nm), due to confinement effects. For example, the band gap of semiconductors and the plasmon frequency of metals shift to higher energies for thinner layers. This should be taken into account before deciding which materials are suitable for the quenching layer: a given material may in fact be less suitable, or more suitable, than would appear from its bulk properties.

FIGS. 12A-12D comprise a series of energy level FIGS. 12A to 12D, illustrating schematically the different quenching mechanisms that may be exploited in the fifth embodiment of the invention. (Also, note that quenching and selective binding may be exploited together in the same embodiment). At the left hand side in each diagram, the energy levels of the reticle material are represented, which will be referred to in this section as the substrate. At the right hand side, there are shown the HOMO and LUMO energy levels of the dye molecule. HOMO and LUMO in this context are well-known acronyms for “highest occupied molecular orbital” and “lowest unoccupied molecular orbital”,” respectively. FIGS. 12A-12D illustrates the mechanisms:

(a) energy transfer of an excited dye to a semiconductor substrate. In case the substrate is a metal (coating 508), the energy of the dye is transferred to a surface plasmon transition.
(b) charge transfer from an excited dye to a semiconductor substrate.
(c) charge transfer of an excited dye to a metal substrate with a low Fermi-level (E_{F}).
(d) charging of an un-excited dye by a metal substrate, of which the Fermi-level is increased by applying an electrical bias (902, FIG. 11). The bias may also be positive, leading to a positively charged dye (electron from dye to metal).

Explaining these quenching mechanisms in a little more detail, in FIG. 12A the oscillating dipole of the excited dye molecule can be quenched by inducing a dipole in a neighboring material that has a resonant dipole frequency. This process is referred to as energy transfer, and can for example occur between neighboring dye molecules (which inherently have a resonant dipole). For the present purpose, plasmon bands (in metals) or excitons (in semiconductors) may also have resonant transitions with a large dipole moment. In other words, energy transfer can also occur to the substrate to which the dye is adsorbed. This provides the quenching effect desired for operation of the inspection process of the fifth embodiment.

Referring to FIGS. 12B and 12C, another route of quenching is charge transfer from an excited dye molecule to a neighboring material. In that case, only an electron e- or hole h⁺ is transferred to the neighboring material. This also causes an efficient quenching of the dye's fluorescence. Charge transfer can occur to semiconductors when valence and conduction band respectively of the substrate is suitably aligned to the HOMO or LUMO level of the dye (FIG. 12B). For example, the inventors have noted that charge transfer from an excited Ruthenium dye molecule attached to a TiO₂ substrate (via carboxyl groups), is the key-operation of the so-called dye-sensitized (Grätzel) solar cell (see Brian O'Regan, Michael Grätzel 1991, Nature 353 (6346): 737-740, which is incorporated by reference herein in its entirety). Charge transfer (either hole or electron or both) can occur to or from metals or semiconductors when the Fermi-level E_{F} of the substrate is suitably aligned to the HOMO or LUMO level of the dye (FIGS. 12B and 12C).

FIG. 12D illustrates charging of the dye even before excitation, as yet another way to quench the fluorescence of a dye. In that case, the chemical potential (Fermi-level E_{F}) of the substrate should be sufficiently low (e.g., by using a noble metal) or high (e.g., by applying an external bias) to inject a charge in the organic dye or vice versa. The additional charge on the dye causes a quenching of the fluorescence.

FIG. 13 shows a sixth embodiment in which the quenching effect is exploited, and enhanced by the application of an insulating layer 904 to form a modified reticle 900. As mentioned above, quenching may be enhanced when a bias voltage is applied to the (metallic) top-layers (504, 508) of the reticle. By applying a bias to the reticle, the dyes that are directly attached to the reticle surface will experience an electric field, which can cause efficient quenching of the dye, as explained above. Alternatively, the bias can cause a charge injection (electrons or holes) into the dye, which is also an efficient way of quenching the dye fluorescence. In other words, the Fermi-level E_{F} of the reticle material is increased or reduced by an external bias to such an extent that the dye becomes negatively or positively charged. Particularly in the case of metallic contaminant particles, however, the bias might be conducted into the particles so that they also quench the fluorescent behavior of the dye, destroying the contrasting behavior which is the basis of detecting the particles by the inspection apparatus 600. To counter this effect, the insulating layer on the reticle 904 can be provided to establish a significantly reduced bias experienced by the contaminants. In that way, the dye molecules on the contaminant do not experienced an electric field or charge injection, thereby maintaining its fluorescence.

In case the insulating layer 904 does not sufficiently shield the bias from the contaminant (e.g., by electron tunneling), it may be favorable to apply an oscillating bias. If the frequency of the bias is high enough, the contaminant may be effectively shielded from the electric field. In that case, the inspection apparatus 600 may be adapted to implement time-gated detection of optical signals received by sensor 608, with the same frequency as the oscillating bias.

In conclusion, in the sixth embodiment the reticle 500 is replaced by a modified reticle 900 with this additional layer 904. As mentioned, the insulating layer 904 can be applied on top of a metallic layer, not shown separately in FIG. 13. Without the insulating layer 904, metal contaminant particles present on the reticle might join in the same quenching behavior as the reticle itself, and be masked from the inspection process. The insulating layer, if properly dimensioned, can electrically isolate the particles from the applied bias voltage, so that they will not cause the same quenching effect as the reticle itself.

As in the earlier embodiments, a suitable dye has to be selected that has a certain affinity for the contamination, either directly or via molecules of a bridging material. The dye preferably a low affinity for the reticle substrate/coating, so that contrast does not depend solely on the quenching effect. The dye preferably has a low vapor pressure to facilitate vapor deposition and removal of the dye. The absorption and emission bands of the dye are preferably in the visible region to facilitate detection, and an optimal emission band can be selected such that efficient quenching occurs on the reticle, but not on the contaminant. For example, in case silver is used a coating layer, the dye preferably emits at the plasmon peak of silver (400-500 nm) so that it is efficiently quenched. Here we assume of course that fluorescence quenching of a dye adsorbed on a contamination is relatively small. Depending on the dye, some metal particles like Fe, Al, Ti, Zn, and their oxides may cause significant fluorescence quenching. Still, if a difference in quenching efficiency can be achieved by an appropriate reticle coating and/or electrical bias, a contrast between reticle and contamination can be achieved and detection is feasible. For example, if the contaminants cause a 10× reduction in fluorescence efficiency, but the reticle causes a 1000× reduction, the sensitivity may be sufficiently high.

Among the different embodiments described above are a number of techniques that can be used as alternatives, or in conjunction with one another. In particular, since the reticle has parts made or coated with contrasting materials, different measures may be taken to prevent fluorescence at different parts of the reticle, when clean. For example, the pattern layer 506 might be coated with a low-affinity coating to repel dye molecules, while the capping layer 508 is effective to quench fluorescence in dye molecules, or vice versa. Similarly, since different types of contaminant material may not have a high affinity for the same dyes, different dyes may be applied in combination, to cover all contaminant particles with one or other of the dyes.

In embodiments that exploit an interaction between the dye molecules and the substrate or contaminant material to inhibit, promote or modify fluorescence, the layer thickness of the dye is an important parameter. In particular, for such embodiments it has been found that a dye layer thickness well below a monolayer is favorable. This can be understood by considering that, where a monolayer or thicker layer of dye molecules is found, the behavior of each molecule is likely to be influenced by neighboring dye molecules as much or more than it is influenced by and underlying substrate, quenching layer, contaminant or the like. For a typical dye, a thickness corresponding to a monolayer may be for example around 0.5 nm. An optimal range for dye layer thickness might then be would be 0.01 nm to 0.1 nm, or in other words, 2 to 20% of a monolayer. In the case of fluorescein dye, the area per molecule is approximately 1 nm². In and example with thickness 0.025 nm (5% of a monolayer), there is only one dye molecule per 20 nm². Of course, the fewer the molecules, the weaker the fluorescence signal, so the optimum thickness is one where the molecules are sufficiently separated from one another not to mask the desired quenching or other effect.

In the above embodiments, we have described the usage of organic dyes on an reticle to perform sensitive spectroscopy-based inspection. To be able to see the fluorescence of the dye only from the contamination, there are options either to selectively remove the dye, or selectively quench the dye by a metal layer. In addition, it was suggested to reduce quenching of the dye by metal reticles by inserting an intermediate buffer layer in between the reticle and dye, to increase the distance between the two (and thereby reducing the quenching).

Further embodiments will now be described, with reference to FIGS. 14 to 20, in which we exploit the fact that certain fluorescent dyes respond differently in different environments, to selectively visualize the dyes on the particles. Properties influenced in this way can include absorption spectrum, emission intensity, and emission peak wavelength. In certain embodiments, for example, we make use of this property to selectively enhance the fluorescence on metal particles, for example, and/or selectively quench the dye on the reticle. Options for achieving this include modifying the environment of the dye with a buffer layer or coating on the reticle. Quenching effects have already been described above in relation to certain embodiments. Enhancing fluorescence may not only include increasing the intensity of the fluorescence generally, but could include increasing it at a selected wavelength by shifting fluorescence to a different wavelength, if the detection apparatus is arranged to discriminate between the unshifted and shifted wavelengths of fluorescence. Such discrimination can be by observing at only one wavelength, or it may be by more sophisticated spectroscopic techniques, comparing intensities at different wavelengths.

For certain dye molecules, the polarity (or pH) of the environment influences one or more optical properties of the dye and can be used to discriminate contamination. Fluorescent dyes of which their absorption spectra are pH dependent include Nile blue and Fluorescein. As another example, hydrophobicity or hydrophilicity of a buffer layer, bridging molecule or coating can be used to tune the fluorescence intensity and/or wavelength of the dye.

FIG. 14 illustrates pH dependence of the absorbance A of dye fluorescein, and is taken from the paper by Margulies et al, “Fluorescein as a model molecular calculator with reset capability”,” Nature Materials 4, 768 (2005). The charge state of the molecule and consequently its absorption spectrum over different wavelengths λ can be tuned by pH. (The emission intensity also depends on the charge state.) Referring to FIG. 14, a fluorescein molecule can be described as a four-state molecular switch. The four ionization states of fluorescein are cation F(+1), neutral F(0), anion F(−1) and dianion F(−2), each of which has a unique absorption spectrum, labeled on the graph. Molar absorptivity at 490 nm is assumed to be 76,900 M−1 cm−1 for the dianion F(−2). Dissolving 6 μM fluorescein in aqueous acetic acid solution (0.015 M, pH=3.3) results in a formation of the neutral form F(0), having a different spectrum. Selective ionization using HCl (0.013 M) or NaOH (0.013 M) solutions results in a fully reversible molecular switch, where each of the four ionization forms can be obtained.

Another environmental influence on fluorescein and other dyes is hydrophobicity or hydrophilicity of the environment. Hydrophilic dyes can have higher fluorescence intensity in an hydrophilic environment (i.e. on a hydrophilic buffer), while hydrophobic dyes can have a higher fluorescence intensity in an hydrophobic environment.

Experiments have been performed depositing a thin layer (0.2 nm) of fluorescein on glass and on glass modified with a layer of Octadecylphosphonic acid (ODPA). ODPA makes the glass surface hydrophobic and affects the behavior of fluorescein. ODPA modification significantly suppressed Fluorescein intensity. Fluorescein dye was deposited on a silicon wafer modified with polystyrene (PS). The hydrophobic PS layer also suppresses the fluorescence intensity compared to the dye on glass. To see the effect of hydrophilicity, another sample was prepared by depositing the dye on UV-ozone treated PS. UV-treatment made the PS surface more hydrophilic (or activated) and this caused an increase in the fluorescence intensity of the fluorescein dye. In conclusion, depositing fluorescein which has OH and carboxyl groups on hydrophilic surface results in high fluorescence intensity and on hydrophobic surface results in low intensity. Similar to pH, therefore, hydrophobicity can be used as a tuning method on fluorescein.

Different dyes may respond differently to different degrees of hydrophobicity/hydrophilicity, which can be measured by contact angle. “Hydrophobic” and “hydrophilic” are relative terms, and their use in the present context does not imply any absolute threshold of contact angle. Hydrophobic surfaces in this context need not be limited to surfaces with a contact angle that is greater than 90 degrees, but could include surfaces with contact angle above 80 degrees, or above 70 degrees. In the experiments above, the unmodified glass substrate had a contact angle 30 (hydrophilic), the ODPA-modified glass substrate had a contact angle 102 (hydrophobic). The PS-modified silicon had contact angle 85 (hydrophobic), while the UV-ozone treated PS modified silicon had contact angle 58 (hydrophilic).

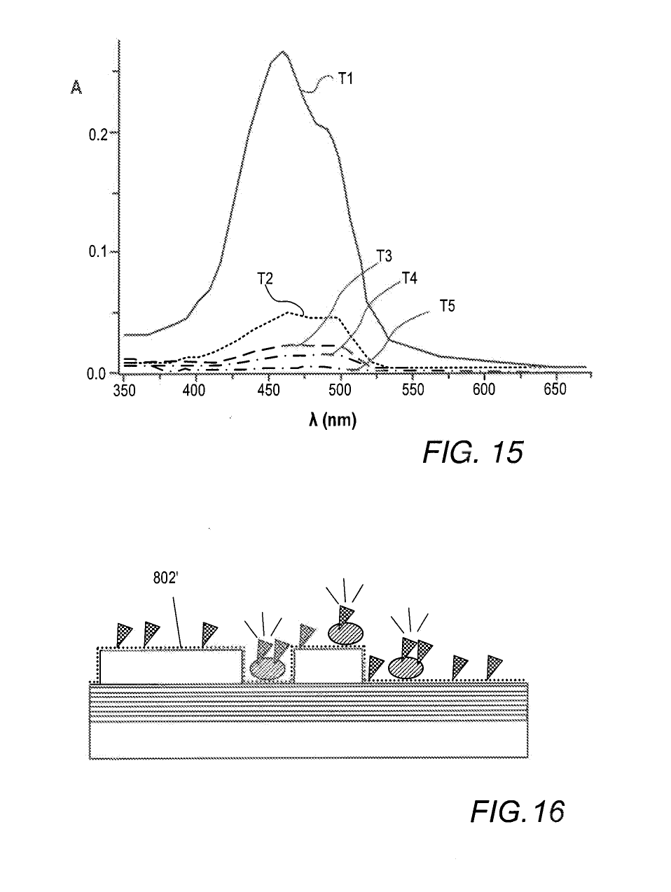

In FIG. 15 the absorption spectra of fluorescein with different thicknesses on glass is seen. When the thickness is great (T1=88 nm), the spectrum becomes similar to F(0) state shown in FIG. 14. As mentioned above, in such a thick layer, the molecules of the dye will be influenced by one another more than they are influenced by the underlying material. When the thickness is decreased (T1>T2>T3>T4>T5) it can be seen that the F(−1) state is reached. This shows that charge state of Fluorescein is sensitive to its environment. It confirms that the charge state (and thus the optical properties) of the dye can be tuned by the polarity of the environment. When the dye is thin, the glass-dye interface is dominant, while when the dye layer is thick, the environment is dominated by the bulk dye itself. The thickness of a dye layer for exploiting this effect may be less than 20 nm, more particularly less than 10 nm.

As an alternative to fluorescein, Nile blue can be used. The absorption and emission maxima of Nile blue are strongly dependent on pH and the solvents used, as shown in the table (source: http://en.wikipedia.org/wiki/Nile_blue). The fluorescence shows especially in non-polar solvents with a high quantum yield. In contrast to fluorescein, Nile blue can show higher intensity on hydrophobic surfaces, and a lower intensity on hydrophilic surfaces. Hydrophobicity can therefore be used to tune the intensity of Nile blue.

TABLE
The absorption and emission of Nile blue in different environments.

| | Absorption λ | Emission λ |
|---|---|---|
| Solvent | max (nm) | max (nm) |
| Toluene | 493 | 574 |
| Acetone | 499 | 596 |
| Dimethylformamide | 504 | 598 |
| Chloroform | 624 | 647 |
| 1-Butanol | 627 | 664 |
| 2-propanol | 627 | 665 |
| Ethanol | 628 | 667 |
| Methanol | 626 | 668 |
| Water | 635 | 674 |
| 1.0N hydrochloric acid | 457 | 556 |
| (pH = 1.0) | | |
| 0.1N sodium hydroxide | 522 | 668 |
| solution (pH = 11.0) | | |
| Ammonia water (pH = 13.0) | 524 | 668 |

FIGS. 16 to 20 illustrate several embodiments in which a dye is selected that can be tuned by hydrophobicity. The pH dependent dyes fluorescein and Nile blue are suitable candidates. Other dyes of course may be identified and used for their particular properties. There are several options to achieve the contrast between contamination and the reticle using the tunability of fluorescence by the polarity of the environment. The contamination in the following description is assumed to be metal, for simplicity. The techniques can be adapted for other types of contamination, as explained in the earlier embodiments.

FIG. 16 illustrates an example in which a hydrophobic coating 802′ on top of the reticle induces a high contrast in fluorescence intensity with respect to particles, with fluorescein as dye. The reticle can be modified by a hydrophobic coating such as metal fluorides or metal nitrides. The metal contaminations are intrinsically more hydrophilic compared to the rest of the modified reticle. As shown schematically in FIG. 16, the fluorescein dye on metal particles will fluoresce strongly, while the dye at the other regions will have low intensity.

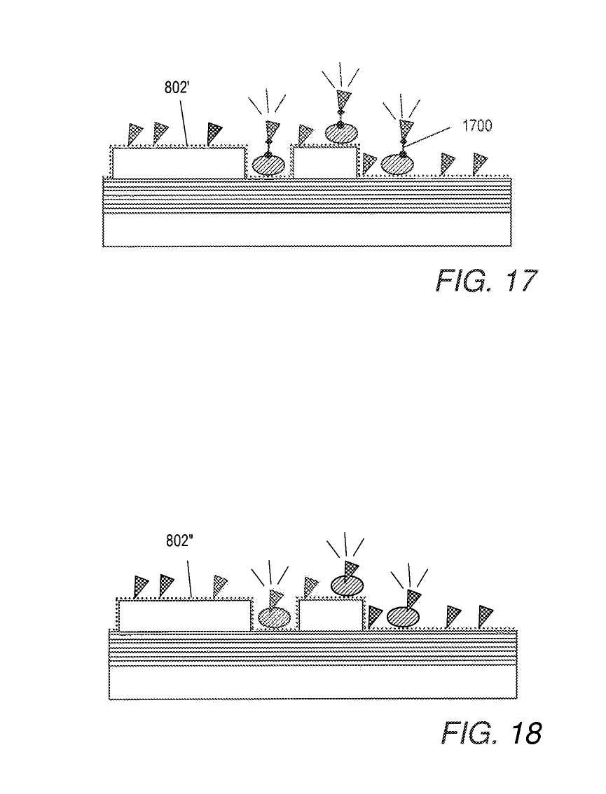

FIG. 17 shows an example in which the performance of fluorescein is further improved by applying a hydrophilic terminated buffer layer of molecules 1700 prior to dye deposition. A buffer layer such as 11-phosphonoundecanoic acid, which has affinity towards metal particles will increase Fluorescein intensity, as shown in FIG. 17.

FIG. 18 illustrates an example that exploits the properties of Nile blue. The reticle can be modified by a hydrophilic coating 802″. The metal contaminations are more hydrophobic compared to the rest of the modified reticle. As illustrated schematically, the intensity of fluorescent emissions from the Nile blue dye on metal particles will be higher compared to the hydrophilic reticle.

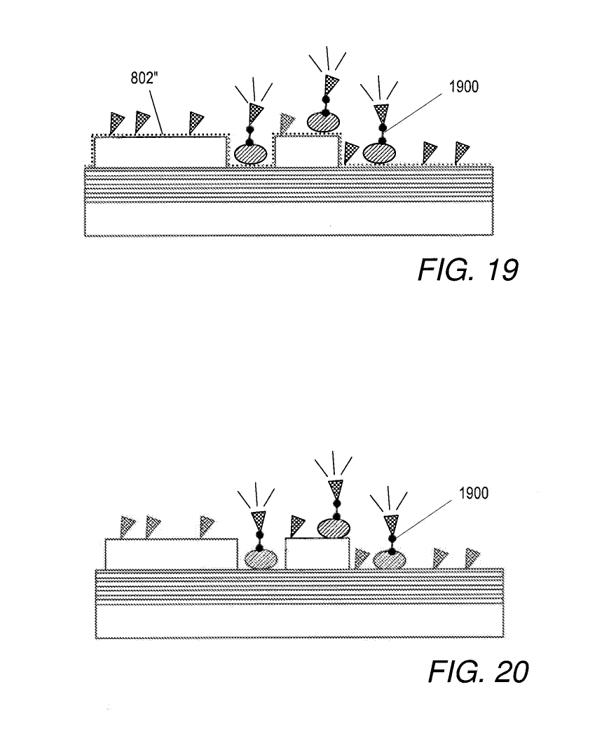

FIG. 19 shows another example using Nile blue dye. Again, a hydrophilic coating 802″ on top of the reticle induces a high contrast in fluorescence intensity with respect to particles. In addition, a hydrophobic buffer layer (molecules 1900) improves the efficiency of the Nile blue dye on the contaminant particles. Octadecylphosphonic acid (ODPA) has affinity towards metal particles and due to its methyl (CH₃) termination, provides a hydrophobic environment. Such a buffer layer can be applied prior to dye deposition to increase intensity of Nile blue as shown in FIG. 19.

FIG. 20 shows an example which again uses Nile blue dye with a hydrophobic buffer layer (molecules 1900) to enhance contrast between the particles and the rest of the reticle. Again, the hydrophobic buffer layer such as ODPA can be applied prior to dye deposition. With such a layer, which has affinity towards metal particles, the hydrophilic coating 802″ may not be necessary, and is omitted in FIG. 20.

As mentioned earlier, bridging molecules may be used, to encourage binding of dye molecules to contaminant. The hydrophilic or hydrophobic buffer layer molecules 1700, 1900 can be chosen also to act as bridging molecules. Hydrophilic buffer molecules 1700 may for example make a strong, selective, covalent bond to the dyes through their end-groups. They already have headgroups for specific binding to metal contaminants. In that sense, (some) of the buffer molecules in principle can be used as bridging molecules as well.

The design of the optical system, the inspection chamber and any necessary preparation chamber are relatively straightforward for the person skilled in the art. Certain design measures can be adopted as described in the earlier international patent application PCT/EP2010/059460 mentioned above. For example, the earlier application describes various measures for illuminating the contaminants and dye molecules from multiple angles, to avoid shadowing by the pattern layer 506.

Another measure described in international patent application PCT/EP2010/059460, which is incorporated by reference herein in its entirety, which can be applied in the present techniques concerns the scanning and searching for contaminants, when the apparatus 600 is only able to detect fluorescence at a given area of the reticle at one time. A scanning process is carried out to cover the entire object. In a preferred embodiment, the object under test will not have any significant spectral response in the illuminating energy range. This is the case, for example, when a lithographic reticle is inspected by a UV laser or lamp as source 602. The signal (and therefore signal-to-noise ratio) of the dye attached to a contaminant particle is essentially independent of the collection area. For this reason, the larger the collection area, the smaller the total inspection time. However, the location accuracy also decreases with a larger the area.

In order to increase the accuracy of detection without unreasonably increasing the inspection time, it is possible to adopt a scanning strategy as follows. Firstly, a first area of the object is scanned. If one or more particles are detected, that first area is then segmented into two or more portions. Those portions are then separately scanned, and the presence of a particle can be detected in each of the segmented portions. The detection process can either stop there, or a further segmentation and scanning process can be performed. This can be repeated as often as desired, to obtain particle detection to a predetermined accuracy. This is also described in international patent application PCT/EP2010/059460, the contents of which are incorporated herein by reference in their entireties.

Embodiments of the present invention provide several advantages. The high efficiency of the fluorescent dye yields a very bright signal and allows an improvement in the capability to detect particles, compared with directly observing the particles themselves.

Embodiments of the methods and apparatus of the disclosure also allow the detection of a particle on a patterned reticle without the necessity of resolving the pattern itself and without comparing the signal to a reference signal. This allows the inspection of “single die” reticles because a complicated die-to-database inspection is not required. In addition, avoiding comparison of two reference objects avoids the associated image alignment issues.

Embodiments of the methods and apparatus of the present disclosure can in principle be used for the inspection of any type of pattern or mask, or indeed any objection, not just an EUV lithographic patterning device. The method can also be used to detect smaller particles which are, for example, less than 100 nanometers, less than 50 nanometers or even less than 20 nanometers, and can be used for detection of all these on the patterned side of substrates such as EUV reticles. The optical system which collects and detects the radiation emitted by the fluorescent dye need not have the power to resolve the individual particles. The presence of the radiation at the fluorescent emission wavelength is sufficient evidence of the contamination in a given area.

As mentioned already the inspection apparatus 600 can be provided as an in-tool device, that is, within a lithographic system, or as a separate apparatus. As a separate apparatus, it can be used for purposes of reticle inspection (e.g., prior to shipping). As an in-tool device, it can perform a quick inspection of a reticle prior to using the reticle for a lithographic process. It may in particular be useful to perform inspections in between the lithographic processes, for example to check after every N exposures whether the reticle is still clean.

As mentioned already, the sensor 608 may be a single large-area sensor, or a pixel array. A pixel array allows imaging of an area of the reticle to identify the location of contaminant with the area (if that is of interest). Imaging can also be performed using a large area sensor (for example a PMT), if the excitation radiation is scanned systematically across the area to be inspected, and the emitted radiation is resolved in time. The filter 606 may be interchangeable to suit different dyes. Processing of signals from the sensor may be implemented in hardware, firmware, software, or any combination thereof. Embodiments of the invention of various component parts of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines or instructions may be described herein as performing certain actions. However, it should be appreciated that such descriptions are merely for convenience and that such actions in fact result from computing devices, processors, controllers, or other devices executing the firmware, software, routines, instructions, etc.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for inspection of an article to detect contaminant particles, the method comprising:
applying a fluorescent dye material to the article;
illuminating the article with radiation at wavelengths suitable for exciting said fluorescent dye material;
monitoring the article for emission of second radiation by the fluorescent dye at a wavelength different from the first radiation; and
generating a signal representing contamination in the event of detecting said second radiation.

2. A method as claimed in claim 1, wherein the fluorescent dye and article material are selected so as not to bind to one another chemically, while the dye will bind chemically to at least one class of contaminant material, a class of contaminant material being for example metal oxides, or non-noble metals such as Al, Sn and Fe.

3. A method as claimed in claim 1, wherein the fluorescent dye is selected to be hydrophilic while at least part of the article material is hydrophobic so that the dye will bind by physisorption to at least one class of contaminant material more strongly than to the article material.

4. A method as claimed in claim 1, wherein, before exposure to contaminants, the article is provided with a coating having a lower affinity for the dye material than for the at least one class of contaminant material, the low-affinity coating selected from: a hydrophobic and/or low surface energy material such as BN, SiC, a fluorinated silane, Octadecylphosphonic acid (ODPA), GeTe, MoS₂ or a noble metal such as Ruthenium.

5. A method as claimed in claim 1, wherein said dye material is applied in conjunction with a bridging material comprising molecules with a first functional group having a high affinity for at least one class of contaminant material and a second functional group adapted for binding to the dye material.

6. A method as claimed in claim 1, wherein said dye material is applied in conjunction with a buffer material comprising molecules with a first functional group having a high affinity for at least one class of contaminant material and a second functional group effective to enhance a fluorescent response of the dye material.

7. A method as claimed in claim 6, wherein said second functional group creates a more hydrophilic environment for the dye molecule than said contaminant material alone, the dye material being for example fluorescein.

8. A method as claimed in claim 6, wherein said second functional group creates a more hydrophobic environment for the dye molecule than said contaminant material alone, the dye material being for example Nile blue.

9. A method as claimed in claim 1, wherein said dye is deposited in an amount corresponding to less than one monolayer, for example less than 0.3 monolayer.

10. A method as claimed in claim 1, wherein before the article is exposed to contaminants article is provided with a coating to quench fluorescence when in contact with said dye, said coating optionally being metallic or semiconducting, said quenching optionally being aided by electrically biasing the article to aid suppression of fluorescence of said when present in contact with the article.

11. A method as claimed in claim 1, wherein said dye material is applied by vapor deposition.

12. A method as claimed in claim 1, wherein the inspected article comprises an EUV lithography reticle.

13. A method as claimed in claim 1, wherein the reticle has reflective portions and absorbing portions of contrasting optical properties at EUV wavelengths, and wherein the dye material and any bridging material and buffer material are selected so that, in the absence of contamination on the article, dye material may be present on one of said portions but with fluorescence suppressed, while dye material is substantially not present on the other of said portions due to low affinity properties of the article material in that other portion.

14. A method as claimed in claim 9, wherein said dye material is applied by vapor deposition.

15. A reticle for use as a patterning device in EUV lithography, the device having reflective portions and absorbing portions of contrasting optical properties at EUV wavelengths, and wherein an overall coating is applied for enhancing contrast between the reticle and contaminant particles in an inspection method without significantly reducing contrast between said optical properties at EUV wavelengths.

16. A reticle as claimed in claim 15, wherein said overall coating is less than 2 nm, for example less than 1 nm in thickness.

17. A reticle as claimed in claim 15, wherein said overall coating comprises a hydrophobic and/or low affinity material such as BN, SiC, a fluorinated silane, Octadecylphosphonic acid (ODPA), GeTe, MoS₂ or a noble metal such as Ruthenium.

18. An apparatus for inspection of articles, the inspection apparatus comprising:
a deposition chamber configured to apply a fluorescent dye material to the article;
a radiation source configured to illuminate the article with radiation at wavelengths suitable for exciting said fluorescent dye;
a sensor configured to monitor the article for emission of second radiation by the fluorescent dye at a wavelength different from the first radiation; and
a signal processor configured to generate a signal indicating the presence of contamination in response to detection of said second radiation.

19. An apparatus as claimed in claim 20, wherein said sensor is provided with an optical filter to exclude said first radiation.
